(19) United States
(12) Patent Application Publication
(10) Pub. No.: US 2013/0340427 A1
(43) Pub. Date: Dec. 26, 2013

(54) ENGINE INCLUDING LOW PRESSURE EGR SYSTEM AND INTERNAL EGR

(71) Applicants: Manuel Angel Gonzalez Delgado, Rochester Hills, MI (US); Charles Dean, Royal Oak, MI (US)

(72) Inventors: Manuel Angel Gonzalez Delgado, Rochester Hills, MI (US); Charles Dean, Royal Oak, MI (US)

(73) Assignee: GM GLOBAL TECHNOLOGY OPERATIONS LLC, Detroit, MI (US)

(21) Appl. No.: 13/532,070

(22) Filed: Jun. 25, 2012

(51) Int. Cl. F02M 25/07; F01N 3/021; F02B 37/00

(52) U.S. Cl. 60/605.2; 60/278

(57) ABSTRACT

An engine assembly may include an engine structure, an exhaust system, an intake system, a valvetrain assembly and an exhaust gas recirculation system. The engine structure may define a combustion chamber and intake and exhaust ports in communication with the combustion chamber. The exhaust system may include an exhaust conduit in communication with exhaust port. The intake system may include a turbocharger in communication with the exhaust conduit and the intake port. The valvetrain assembly may provide internal recirculation of exhaust gas within the combustion chamber. The exhaust gas recirculation system may include an EGR line extending from the exhaust conduit at a location between the turbocharger and an outlet of the exhaust conduit to the intake system and may provide communication between the intake and exhaust systems.

### FIELD

The present disclosure relates to engine exhaust gas recirculation systems.

### BACKGROUND

This section provides background information related to the present disclosure which is not necessarily prior art.

Internal combustion engines may include exhaust gas recirculation systems to provide exhaust gas to the combustion chambers for a subsequent combustion event. In order to provide exhaust gas flow to the combustion chambers a pressure differential is needed between the exhaust flow path of the engine and the location in the intake system where the exhaust gas is reintroduced.

### SUMMARY

An engine assembly may include an engine structure, an exhaust system, an intake system, a valvetrain assembly and an exhaust gas recirculation system. The engine structure may define a combustion chamber and intake and exhaust ports in communication with the combustion chamber. The exhaust system may include an exhaust conduit in communication with exhaust port. The intake system may include a turbocharger in communication with the exhaust conduit and the intake port. The valvetrain assembly may include an intake valve located in the intake port, an intake valve lift mechanism engaged with the intake valve, an intake cam lobe engaged with the intake valve lift mechanism and defining an intake lift region adapted to open the intake valve, an exhaust valve located in the exhaust port, an exhaust valve lift mechanism engaged with the exhaust valve, and a first exhaust cam lobe engaged with the exhaust valve lift mechanism and defining an EGR lift region at least partially rotationally aligned with the intake lift region and adapted to open the exhaust valve. The exhaust gas recirculation system may include an EGR line extending from the exhaust conduit at a location between the turbocharger and an outlet of the exhaust conduit to the intake system and may provide communication between the intake and exhaust systems.

In another arrangement an engine assembly may include an engine structure, an intake system, an exhaust system, a valvetrain assembly and a backpressure control valve. The engine structure may define a combustion chamber and intake and exhaust ports in communication with the combustion chamber. The intake system may be in communication with the intake port. The exhaust system may include an exhaust conduit in communication with exhaust port and a diesel particulate filter located in the exhaust conduit. The valvetrain assembly may include an intake valve located in the intake port, an intake valve lift mechanism engaged with the intake valve, an intake cam lobe engaged with the intake valve lift mechanism and defining an intake lift region adapted to open the intake valve, an exhaust valve located in the exhaust port, an exhaust valve lift mechanism engaged with the exhaust valve and operable in first and second modes, and a first exhaust cam lobe engaged with the exhaust valve lift mechanism and defining an EGR lift region at least partially rotationally aligned with the intake lift region. The EGR lift region may open the exhaust valve during the first mode and the exhaust valve may be maintained in a closed position when the EGR lift region engages the exhaust valve lift mechanism during the second mode. The backpressure control valve may be located downstream of the diesel particulate filter and may control a pressure differential between the intake and exhaust systems and recirculation of exhaust gas from the exhaust system to the intake system.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only and are not intended to limit the scope of the present disclosure in any way.

FIG. 1 is a schematic illustration of an engine assembly according to the present disclosure;

FIG. 2 is a schematic section view of the engine assembly from FIG. 1;

FIG. 3 is a schematic illustration of the valvetrain assembly shown in FIG. 2;

FIG. 4 is a schematic section view of an exhaust valve lift mechanism from the valvetrain assembly shown in FIGS. 2 and 3;

FIG. 5 is an additional schematic section view of the exhaust valve lift mechanism from the valvetrain assembly shown in FIGS. 2 and 3;

FIG. 6 is a schematic illustration of an alternate engine assembly according to the present disclosure; and

FIG. 7 is a schematic illustration of another alternate engine assembly according to the present disclosure.

Corresponding reference numerals indicate corresponding parts throughout the several views of the drawings.

### DETAILED DESCRIPTION

Examples of the present disclosure will now be described more fully with reference to the accompanying drawings. The following description is merely exemplary in nature and is not intended to limit the present disclosure, application, or uses.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. As used herein, the term “module” refers to an application specific integrated circuit (ASIC), an electronic circuit, and/or a processor (shared, dedicated, or group) and memory that execute one or more software or firmware programs.

When an element or layer is referred to as being “on,” “engaged to,” “connected to” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

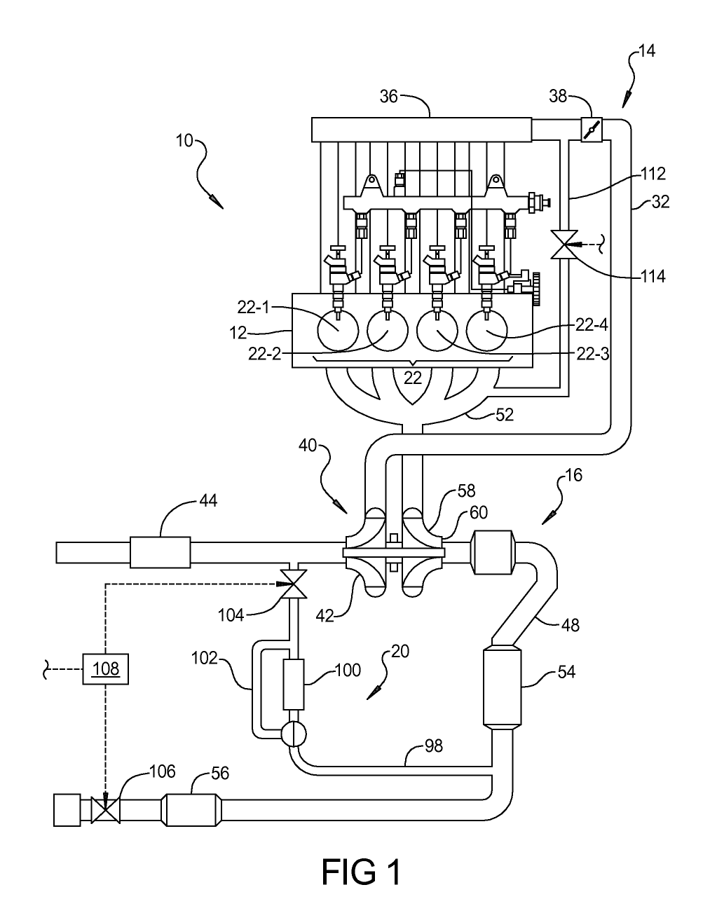

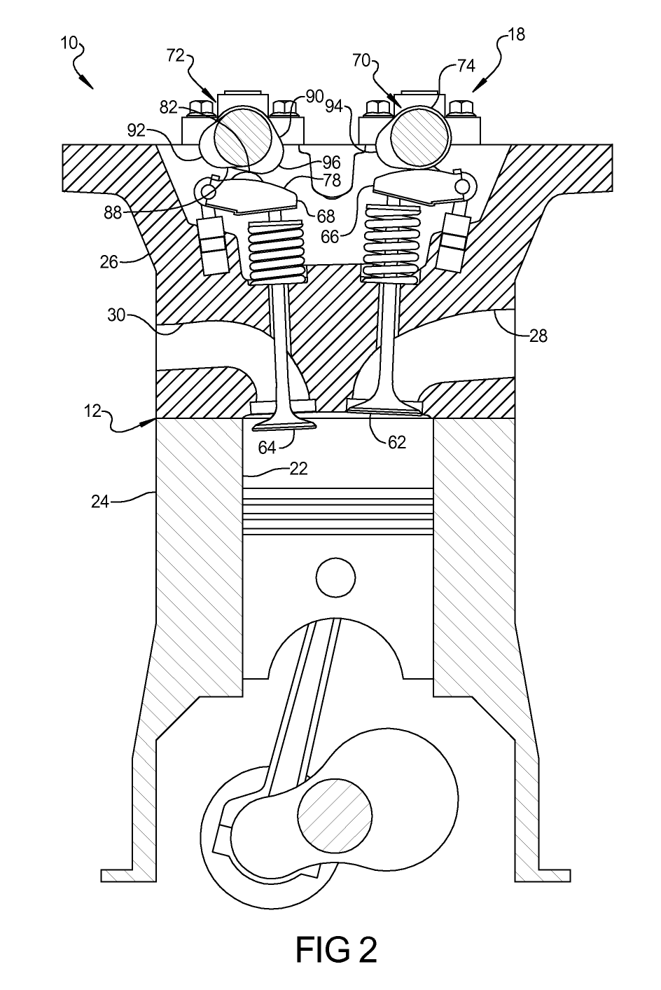

With reference to FIGS. 1 and 2, an engine assembly 10 may include an engine structure 12, an intake system 14, an exhaust system 16, a valvetrain assembly 18 and an exhaust gas recirculation (EGR) assembly 20. The engine structure 12 may define cylinder bores 22 forming combustion chambers. The engine structure 12 may include an engine block 24 defining the cylinder bores 22 and a cylinder head 26 coupled to the engine block 24 and defining intake and exhaust ports 28, 30 in communication with the combustion chambers.

An inline engine configuration having four cylinders (22-1, 22-2, 22-3, 22-4) is schematically shown in FIG. 1 for illustration purposes only with a single cylinder illustrated in the section view shown in FIG. 2 for simplicity. It is understood that the features discussed relative to the cylinder shown in FIG. 2 apply equally to the remaining cylinders of the engine assembly 10. Additionally, it is understood that the present teachings apply to any number of piston-cylinder arrangements and a variety of reciprocating engine configurations including, but not limited to, V-engines, inline engines, and horizontally opposed engines, as well as both overhead cam and cam-in-block configurations.

The intake system 14 may include an intake conduit 32, an intake manifold 36 coupled to the cylinder head 26 and in communication with the intake conduit 32, a throttle valve 38 in the intake conduit 32 and controlling air flow to intake port 28 through the intake manifold 36, a turbocharger 40 including an intake side 42 (compressor) located in the intake conduit 32 and an air cleaner 44 located in the intake conduit 32. The intake conduit 32 may define an air inlet into the intake system 14 and the turbocharger 40 may be in communication with the intake ports 28 via the intake manifold 36. While a single turbocharger 40 is illustrated, it is understood that the present disclosure applies equally to arrangements including multiple turbochargers.

The exhaust system 16 may include an exhaust conduit 48, an exhaust manifold 52 coupled to the cylinder head 26 and in communication with the exhaust conduit 48, and a diesel particulate filter (DPF) 54 and a selective catalytic reduction (SCR) catalyst 56 located in the exhaust conduit 48. While illustrated as including an individual DPF 54 and an individual SCR catalyst 56, it is understood that the present disclosure is not limited to such arrangements. The DPF 54 may alternatively be included in a combined DPF/SCR catalyst. Further, the SCR catalyst 56 may alternatively be located upstream of the DPF 54 or an additional SCR catalyst (not shown) may be included upstream of the DPF 54. The exhaust side 58 (turbine) of the turbocharger 40 may be located in the exhaust conduit 48 and may include a turbine wheel in communication with and driven by exhaust gas flowing through the exhaust conduit 48. The exhaust side 58 of the turbocharger 40 may include a variable exhaust gas outlet 60 that controls an exhaust gas flow restriction through the turbocharger 40. The variable exhaust gas outlet 60 may be in the form of a variable nozzle.

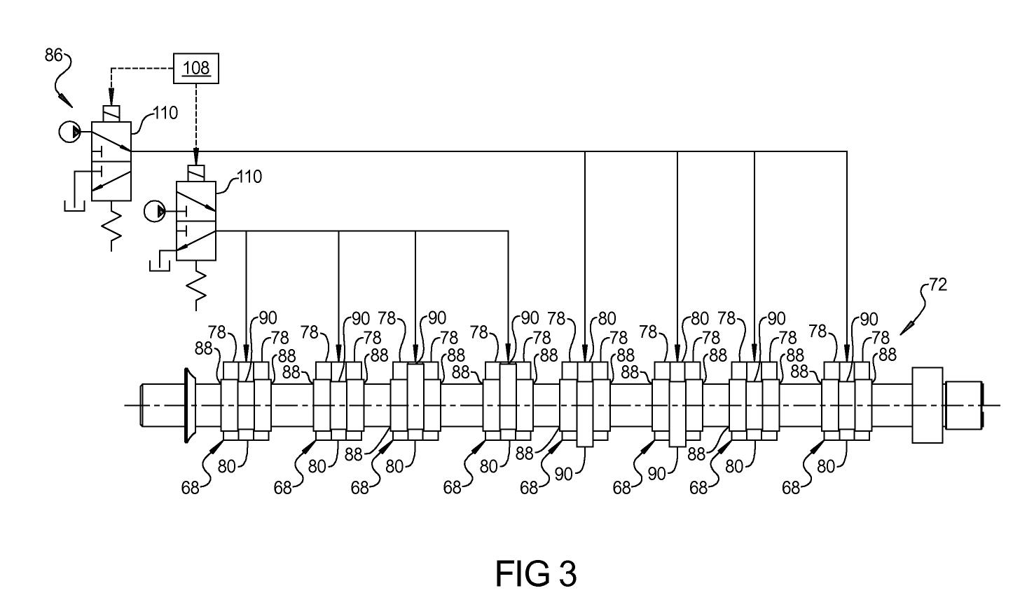

As seen in FIGS. 2 and 3, the valvetrain assembly 18 may include intake valves 62 located in the intake ports 28, exhaust valves 64 located in the exhaust ports 30, intake valve lift mechanisms 66 supported on the cylinder head 26 and engaged with the intake valves 62, exhaust valve lift mechanisms 68 supported on the cylinder head 26 and engaged with the exhaust valves 64, an intake camshaft 70 supported for rotation on the cylinder head 26 and engaged with the intake valve lift mechanisms 66 and an exhaust camshaft 72 supported for rotation on the cylinder head 26 and engaged with the exhaust valve lift mechanisms 68. The intake camshaft 70 may include intake cam lobes 74 engaged with each of the intake valve lift mechanisms 66. The intake camshaft 70 may include an intake cam phaser (not shown) and the intake valve lift mechanism 66 may take a variety of forms including, but not limited to, conventional or variable valve lift mechanisms.

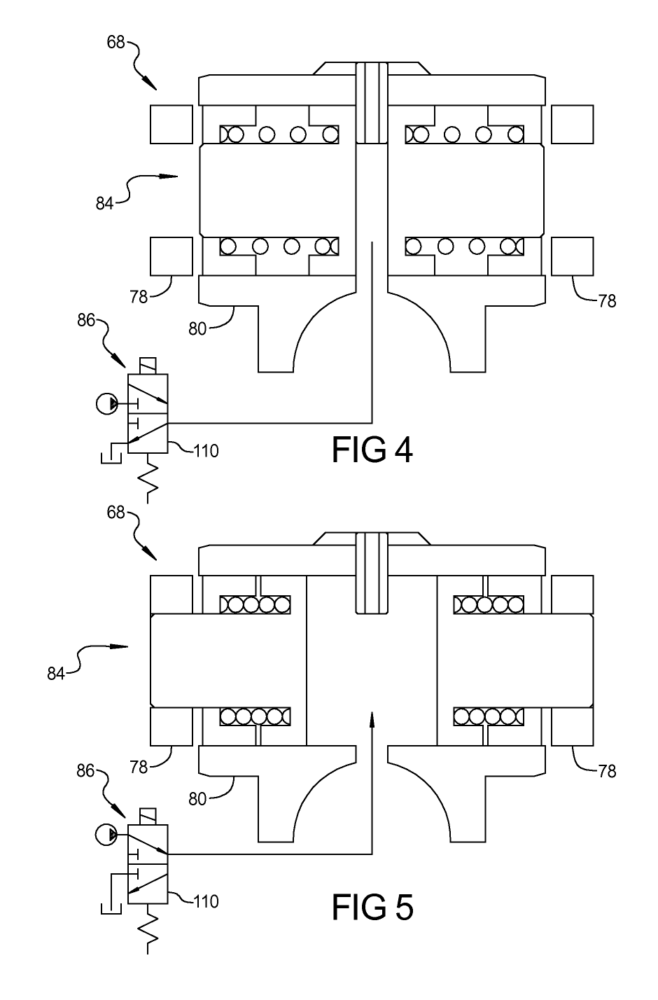

The exhaust valve lift mechanisms 68 may form hydraulically actuated deactivating valve lift mechanisms operable in first and second modes. In the present non-limiting example, and as seen in FIGS. 2-5, the exhaust valve lift mechanism 68 may be in the form of a rocker arm including a pair of outer arms 78, an inner arm 80 including a roller 82 and a locking mechanism 84 selectively coupling the outer arms 78 to the inner arm 80. As seen in FIGS. 4 and 5, the locking mechanism 84 may be switched between locked (FIG. 5) and unlocked (FIG. 4) positions by a pressurized fluid supply 86. The locking mechanism 84 may be normally biased to the unlocked position (FIG. 4) for operation in the second mode. The locking mechanism 84 may secure the outer arms 78 for displacement with the inner arm 80 during the first mode (FIG. 5) and may allow relative displacement between the outer arms 78 and the inner arm 80 during the second mode (FIG. 4). While both exhaust valve lift mechanisms 68 for each cylinder are shown as deactivating valve lift mechanisms in FIG. 3, it is understood that the present disclosure is not limited to such arrangements and applies equally to arrangements where only one exhaust valve lift mechanism 68 per cylinder is a deactivating valve lift mechanism.

The exhaust camshaft 72 may include a first exhaust cam lobe 88 engaged with each of the outer arms 78 and a second exhaust cam lobe 90 located between the first exhaust cam lobes 88 and engaged with the inner arm 80. Each of the first exhaust cam lobes 88 may define an EGR lift region 92 at least partially rotationally aligned with an intake lift region 94 defined by a corresponding one of the intake cam lobes 74. The second exhaust cam lobes 90 may define exhaust lift regions 96 rotationally offset from the EGR lift region 92 and the intake lift regions 94.

As seen in FIG. 2, the lift regions 92, 94, 96 may generally be defined as regions of the cam lobes 74, 88, 90 including lobe peaks that extend from a base circle region to provide valve lift. The exhaust valve 64 may be displaced to an open position when the peak of the second exhaust cam lobe 90 engages the exhaust valve lift mechanism 68 during both the first and second modes. The exhaust valve 64 may be displaced to an open position when the peaks of the first exhaust cam lobes 88 engage the exhaust valve lift mechanism 68 during the first mode and the exhaust valve 64 may remain in the closed position when the peaks of the first exhaust cam lobes 88 engage the exhaust valve lift mechanism 68 during the second mode. The first exhaust cam lobes 88 may provide internal exhaust gas recirculation when the exhaust valve lift mechanism 68 is operated in the second mode. An entirety of the opening of the exhaust valve 64 by the EGR lift region 92 during the first mode may occur while a corresponding intake valve 62 (i.e., intake valve for the same cylinder) is open.

The exhaust gas recirculation assembly 20 may include an EGR line 98, an EGR cooler 100 and cooler bypass 102 located in the EGR line 98, an EGR control valve 104 and a backpressure control valve 106. The EGR line 98 may extend from the exhaust conduit 48 at a location between the turbocharger 40 and an outlet of the exhaust conduit 48 to the intake system 14 to provide communication between the intake and exhaust systems 14, 16.

In the non-limiting example shown in FIG. 1, the EGR control valve 104 may be located at the outlet of the EGR line 98 and may control exhaust gas recirculation flow to the intake system 14 from the EGR line 98. The backpressure control valve 106 may be located in the exhaust conduit 48 at a location between the EGR line 98 and an outlet of the EGR line 98. In the non-limiting example shown in FIG. 1, the backpressure control valve 106 is located at the outlet of the exhaust conduit 48. The DPF 54 may be located in the exhaust conduit 48 at a location between the exhaust side 58 of the turbocharger 40 and the backpressure control valve 106. The arrangement discussed above provides an internal EGR system in combination with a low pressure EGR system.

More specifically, the engine assembly 10 may additionally include a control module 108 in communication with the EGR control valve 104 and the backpressure control valve 108. As seen in FIGS. 3-5, the pressurized fluid supply 86 for the exhaust valve lift mechanisms 68 may include oil control valves 110 in communication with and controlled by the control module 108.

The backpressure control valve 106 may be used to control the pressure differential between the intake system 14 and the exhaust system 16 for both the internal EGR system and the low pressure EGR system to adjust recirculation of exhaust gas in the engine assembly 10. The exhaust valve lift mechanisms 68 and the EGR control valve 104 may be adjusted by the control module 108 to provide a desired amount of exhaust gas recirculation during engine operation. The throttle valve 38 and the variable exhaust gas outlet 60 of the turbocharger 40 may also be used to control the pressure differential between the intake system 14 and the exhaust system 16 to further adjust the amount of exhaust gas recirculated in the engine assembly 10. In some arrangements, the exhaust gas recirculation assembly 20 may additionally include a bypass passage 112 and a bypass valve 114 located in the bypass passage 112 and in communication with the control module 108. The bypass passage 112 may extend from the exhaust manifold 52 to a region of the intake conduit 32 located between the intake throttle valve 38 and the intake manifold 36 to provide further control of exhaust gas recirculation.

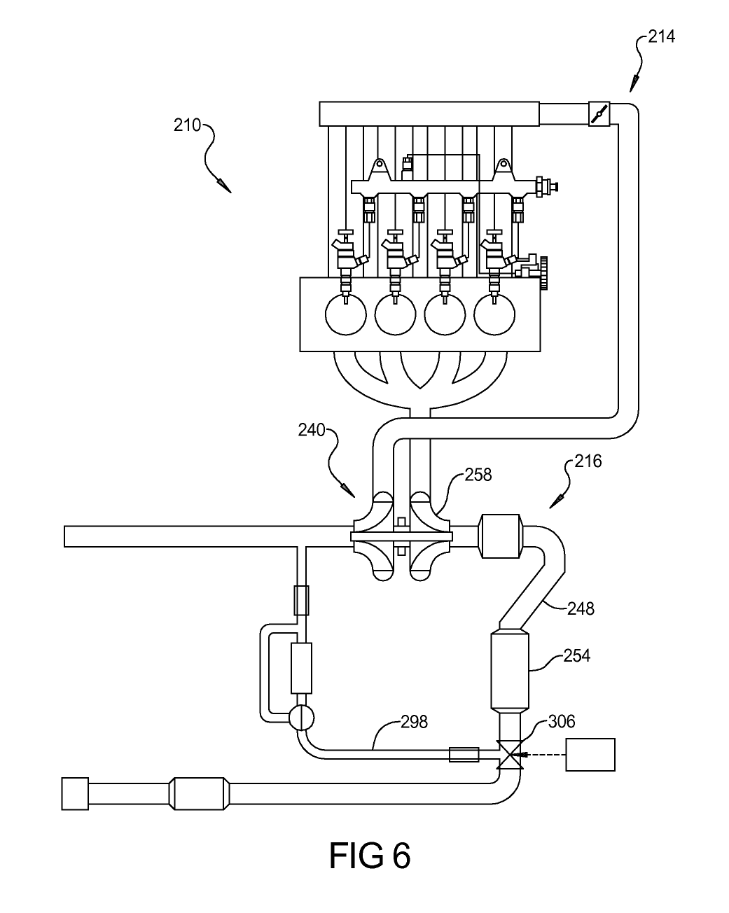

An alternate engine assembly 210 is shown in FIG. 6. The engine assembly 210 may be similar to the engine assembly 10. For simplicity the description of the common features will not be described again in detail with the understanding that the description of the engine assembly 10 applies equally to the engine assembly 210, with the exceptions noted below.

The engine assembly 210 may include a three-way valve 306 in place of the EGR control valve 104 and the backpressure control valve 106 from the engine assembly 10. The valve 306 may form both a backpressure control valve and an EGR control valve for the low pressure EGR system. The valve 306 may be located in the exhaust conduit 248 at an inlet to the EGR line 298. The DPF 254 may be located in the exhaust conduit 48 at a location between the exhaust side 258 of the turbocharger 240 and the valve 306. The valve 306 may control the pressure differential between the intake system 214 and the exhaust system 216 for both the internal EGR system and the low pressure EGR system to adjust recirculation of exhaust gas in the engine assembly 210. Additionally, the valve 306 may control exhaust gas recirculation from the low pressure EGR system by adjusting exhaust gas flow through the EGR line 298.

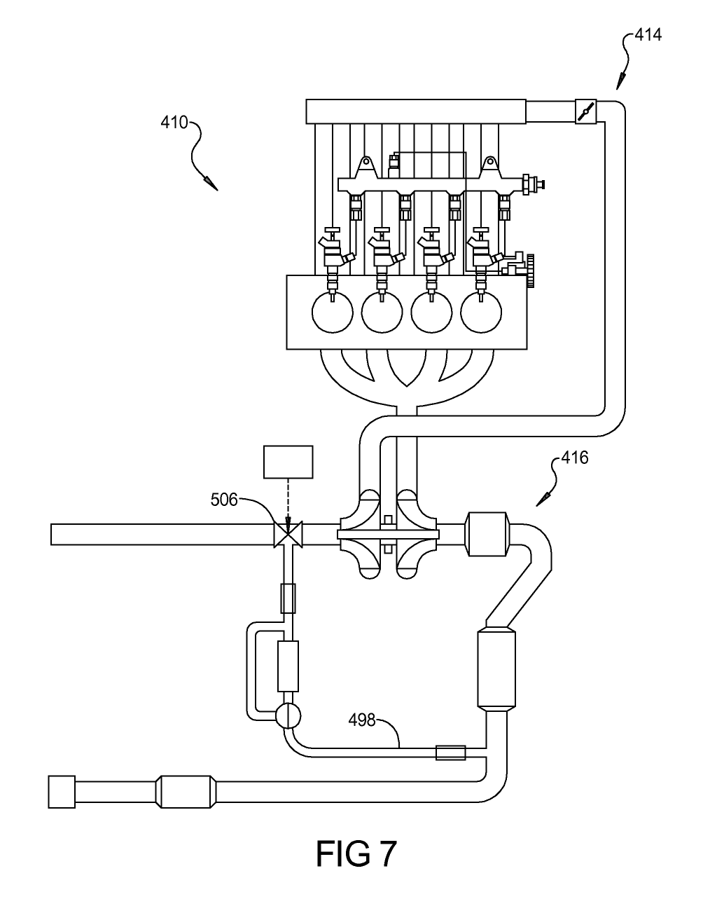

Another alternate engine assembly 410 is shown in FIG. 7. The engine assembly 410 may also be similar to the engine assembly 10. For simplicity the description of the common features will not be described again in detail with the understanding that the description of the engine assembly 10 applies equally to the engine assembly 410, with the exceptions noted below.

The engine assembly 410 may include a three-way valve 506 in place of the EGR control valve 104 and the backpressure control valve 106 from the engine assembly 10. The valve 506 may be located in the intake conduit 32 at the outlet of the EGR line 498. The valve 506 may control the pressure pressure differential between the intake system 414 and the exhaust system 416 for both the internal EGR system and the low pressure EGR system to adjust recirculation of exhaust gas in the engine assembly 410. In the arrangement of FIG. 7, the pressure differential may be controlled by adjusting the restriction in the intake conduit 14. The valve 506 may also form an EGR control valve to control exhaust gas recirculation from the low pressure EGR system by adjusting exhaust gas flow through the EGR line 498.

While not illustrated in FIGS. 6 and 7, it is understood that either of the alternate engine assemblies 210, 410 may also include an EGR bypass arrangement similar to the bypass passage 112 and the bypass valve 114 shown in FIG. 1.

In each of the arrangements discussed above, the internal EGR system may be used as the high pressure EGR system, eliminating the typical high pressure EGR lines and cooler, eliminating the potential for high pressure EGR cooler fouling.

What is claimed is:

1. An engine assembly comprising:
an engine structure defining a combustion chamber and intake and exhaust ports in communication with the combustion chamber;
an exhaust system including an exhaust conduit in communication with exhaust port;
an intake system including a turbocharger in communication with the exhaust conduit and the intake port;
a valvetrain assembly including an intake valve located in the intake port, an intake valve lift mechanism engaged with the intake valve, an intake cam lobe engaged with the intake valve lift mechanism and defining an intake lift region adapted to open the intake valve, an exhaust valve located in the exhaust port, an exhaust valve lift mechanism engaged with the exhaust valve, and a first exhaust cam lobe engaged with the exhaust valve lift mechanism and defining an EGR lift region at least partially rotationally aligned with the intake lift region and adapted to open the exhaust valve; and
an exhaust gas recirculation system including an EGR line extending from the exhaust conduit at a location between the turbocharger and an outlet of the exhaust conduit to the intake system and providing communication between the intake and exhaust systems.

2. The engine assembly of claim 1, wherein the exhaust gas recirculation system includes a backpressure control valve in the exhaust conduit at a location between the EGR line and the outlet of the exhaust conduit.

3. The engine assembly of claim 2, wherein the backpressure control valve is located at the outlet of the exhaust conduit.

4. The engine assembly of claim 2, wherein the backpressure control valve is located at an inlet of the EGR line.

5. The engine assembly of claim 2, wherein the exhaust system includes a diesel particulate filter located in the exhaust conduit at a location between the turbocharger and the backpressure control valve.

6. The engine assembly of claim 2, wherein the exhaust gas recirculation system includes an EGR control valve located at an outlet of the EGR line and adapted to control communication between the intake and exhaust systems.

7. The engine assembly of claim 1, wherein the exhaust valve lift mechanism is operable in first and second modes, the first mode including the exhaust valve being opened when the EGR lift region engages the exhaust valve lift mechanism and the second mode including the exhaust valve lift mechanism maintaining the exhaust valve in a closed position when the EGR lift region engages the exhaust valve lift mechanism.

8. The engine assembly of claim 7, wherein the valvetrain assembly includes a second exhaust cam lobe defining an exhaust lift region rotationally offset from the EGR lift region and engaged with the exhaust valve lift mechanism.

9. The engine assembly of claim 7, wherein an entirety of the exhaust valve opening provided by the EGR lift region during the first mode occurs while the intake valve is open.

10. The engine assembly of claim 1, wherein the intake system includes a throttle valve adapted to control an air flow to the intake port.

11. The engine assembly of claim 1, wherein the exhaust gas recirculation system includes a bypass passage extending from a location in the exhaust system between the exhaust port and the turbocharger to a location in the intake system between the turbocharger and the intake port with a bypass control valve located in the bypass passage and adapted to control exhaust gas flow from the exhaust system to the intake system through the bypass passage.

12. The engine assembly of claim 1, wherein the exhaust gas recirculation system includes an EGR control valve located in the intake system at a location between an inlet of the intake system and the turbocharger, the EGR control valve in communication with an outlet of the EGR line and controlling exhaust gas flow through the EGR line to the intake system.

13. The engine assembly of claim 1, wherein the turbocharger includes a variable exhaust gas outlet adapted to control an exhaust gas flow restriction through the turbocharger.

14. An engine assembly comprising:
an engine structure defining a combustion chamber and intake and exhaust ports in communication with the combustion chamber;
an intake system in communication with the intake port;
an exhaust system including an exhaust conduit in communication with exhaust port and a diesel particulate filter located in the exhaust conduit;
a valvetrain assembly including an intake valve located in the intake port, an intake valve lift mechanism engaged with the intake valve, an intake cam lobe engaged with the intake valve lift mechanism and defining an intake lift region adapted to open the intake valve, an exhaust valve located in the exhaust port, an exhaust valve lift mechanism engaged with the exhaust valve and operable in first and second modes, and a first exhaust cam lobe engaged with the exhaust valve lift mechanism and defining an EGR lift region at least partially rotationally aligned with the intake lift region and adapted to open the exhaust valve during the first mode, the exhaust valve being maintained in a closed position when the EGR lift region engages the exhaust valve lift mechanism during the second mode; and
a backpressure control valve located downstream of the diesel particulate filter and adapted to control a pressure differential between the intake and exhaust systems and control recirculation of exhaust gas from the exhaust system to the intake system.

15. The engine assembly of claim 14, further comprising an EGR line extending from the exhaust conduit at a location downstream of the diesel particulate filter to the intake system and providing communication between the intake and exhaust systems.

16. The engine assembly of claim 15, further comprising an EGR control valve located in the EGR line and adapted to vary exhaust gas recirculation flow from the exhaust system to the intake system through the EGR line.

17. The engine assembly of claim 16, wherein the backpressure control valve is located at an outlet of the exhaust conduit.

18. The engine assembly of claim 15, wherein the backpressure control valve is a three-way valve located in the exhaust conduit at an inlet of the EGR line that controls backpressure within the exhaust system and forms an EGR control valve controlling exhaust gas flow from the exhaust system to the intake system through the EGR line.

19. The engine assembly of claim 15, further comprising a turbocharger in communication with the exhaust conduit and the intake port and driven by exhaust gas flowing through the exhaust conduit with the turbocharger being in communication with the exhaust conduit at a location upstream of the EGR line.

20. The engine assembly of claim 14, wherein the valvetrain assembly includes a second exhaust cam lobe defining an exhaust lift region rotationally offset from the EGR lift region and engaged with the exhaust valve lift mechanism.
